(19) United States
(12) Patent Application Publication
(10) Pub. No.: US 2012/0158841 A1
(43) Pub. Date: Jun. 21, 2012

(54) PROXY COMMUNICATIONS OF NON-PERSON ENTITIES

(75) Inventor: Hai Liu, Sammamish, WA (US)

(73) Assignee: Microsoft Corporation, Redmond, WA (US)

(21) Appl. No.: 12/972,414

(22) Filed: Dec. 17, 2010

(51) Int. Cl. G06F 15/16

(52) U.S. Cl. 709/204

(57) ABSTRACT

The disclosed architecture enables a person-entity to perform actions (e.g., post a message) as a non-person entity (e.g., group, organization, team, brand, etc.) on a microblogging platform using distribution groups. Existing directory services distribution groups can be utilized as proxies of non-person entity. The owner and co-owners of the distribution group, for example, are the only “spoke persons” that can post as the distribution group. The distribution group is allowed to be designated as a first class user account in the enterprise microblog platform so that users can follow the distribution group post. Additionally, the list of distribution groups (or non-user accounts) to which a user can post a message is automatically presented. Tracking of the real user who posted as a distribution groups is also performed.

### BACKGROUND

Communications is an essential component for the success of a business. Given that employees are no longer necessarily on the corporate campus at all times, communications such as email and instant messaging have assumed an important role in these communications. Moreover, blogging has also entered the communications realm as a tool for conveying information in the corporate environment. Not only employees, but public users as well blog on a wide variety of topics.

In the corporate environment, product teams and employee technical groups are typically formed to focus on certain aspects of projects and tasks. Thus, information can be communicated via email, for example, to only specific groups of users on relevant topics as an efficient way communications. However, generally, the ability to communicate on behalf of a group as the group is problematic, and more specifically, in a blogging environment.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a person-entity (user) to perform actions (e.g., post messages) on behalf of a non-person entity (e.g., group, organization, team, brand, etc.) as the non-person entity such as on a microblogging platform. Existing directory services distribution groups can be utilized as proxies of non-person entity. The owner and co-owners of the distribution group, for example, are the only “spoke persons” that can post as the distribution group. The distribution group is allowed to be designated as a first class user account in the enterprise microblog platform so that users can follow the distribution group post. Additionally, the list of distribution groups (or non-user accounts) to which a user can post a message is automatically presented. Tracking of the real user who posted as a distribution groups is also performed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented proxy system in accordance with the disclosed architecture.

FIG. 2 illustrates a microblogging system that employs the disclosed distribution group proxy architecture.

FIG. 3 illustrates a computer-implemented proxy method in accordance with the disclosed architecture.

FIG. 4 illustrates further aspects of the method of FIG. 3.

FIG. 5 illustrates an alternative computer-implemented proxy method in accordance with the disclosed architecture.

FIG. 6 illustrates further aspects of the method of FIG. 5.

FIG. 7A and FIG. 7B illustrate an alternative proxy method of utilizing distribution groups as a proxy for a non-person entity.

FIG. 8 illustrates a block diagram of a computing system that executes the proxy of non-person entities using distribution groups in a group infrastructure in accordance with the disclosed architecture.

### DETAILED DESCRIPTION

The disclosed architecture employs an existing group infrastructure (e.g., a directory service) as proxy for non-person entities (e.g., group, team, brand, etc.). Only a person-entity (human user) that has been designated an owner and or a co-owner of a distribution group is allowed to act as a spokesperson for the non-person entity. When the proxy action is initiated by the user, the architecture automatically responds with the presentation of a list of distribution groups to which a user (person-entity) can perform acts (e.g., post messages). For auditing purposes, tracking of the human user is provided to audit the identity of the user who posted information as a distribution group. The architecture is particularly suited for use in an enterprise microblogging platform to follow a non-person entity.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

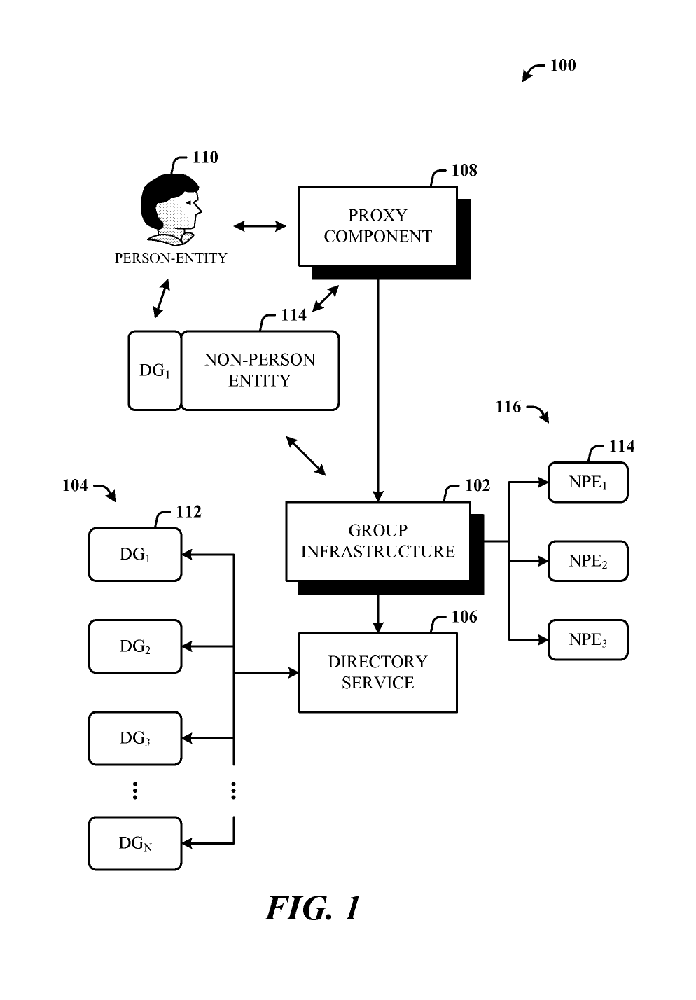

FIG. 1 illustrates a computer-implemented proxy system 100 in accordance with the disclosed architecture. The system 100 includes a group infrastructure 102 that includes distribution groups (DG) 104 as part of a directory service 106. A proxy component 108 enables a person-entity 110 to utilize a distribution group 112 (e.g., DG₁) as a proxy to perform actions as a non-person entity 114 of non-person entities (NPEs) 116.

The distribution group 112 is associated with a distribution group owner (e.g., the person-entity 110) and the owner performs an action on behalf of the non-person entity 114. The distribution group 112 is associated with a distribution group co-owner (e.g., the person-entity 110) and the co-owner performs an action on behalf of the non-person entity 114. The directory service 106 can be part of an enterprise microblogging platform and the distribution group 112 can be a first class user account of the directory service 106. The non-person entity 114 can be an enterprise group, enterprise team, enterprise organization, or an enterprise brand, for example. Other group types as well can be employed to the benefit of the disclosed architecture. The directory service 106 presents a list of distribution groups (e.g., the distribution groups 104) of which the person-entity 110 is a member and filters the list of distribution groups of which the person-entity 110 has ownership status (e.g., owner, co-owner, etc.). The group infrastructure 102 (or the proxy component 108) tracks the actions of the person-entity 110 performed as the non-person entity 114.

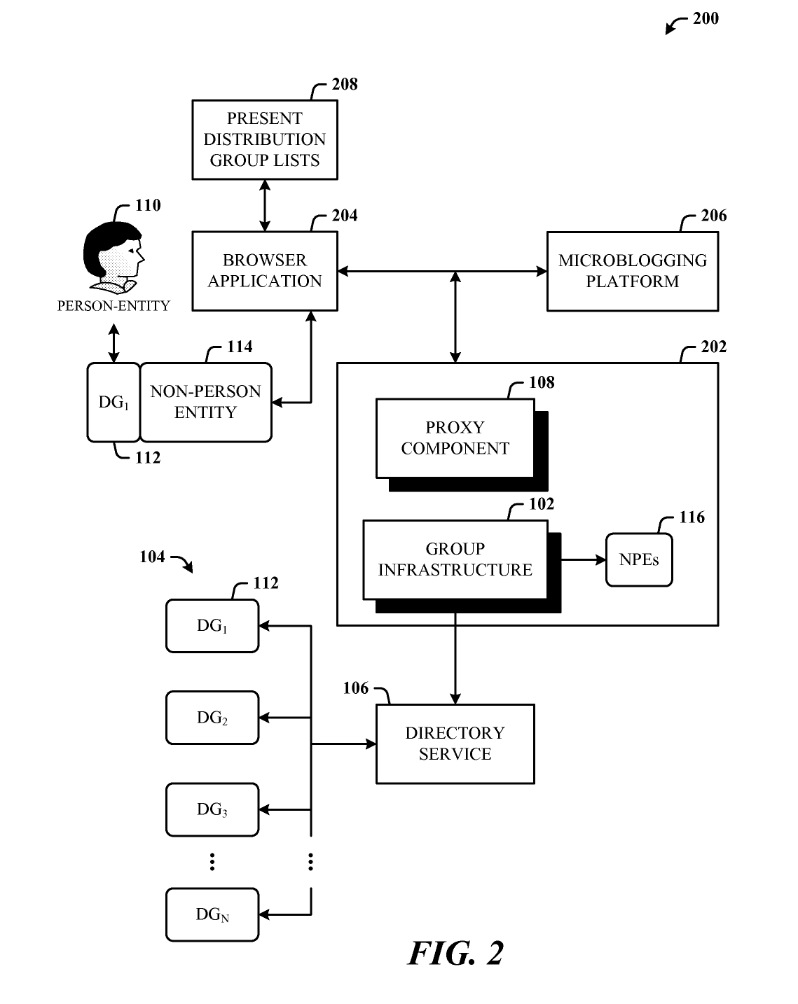

FIG. 2 illustrates a microblogging system 200 that employs the disclosed distribution group proxy architecture. Here, the proxy component 108 and group infrastructure 102 can be a component 202 that resides between a browser application 204 and a microblogging platform 206. The component 202 communicates to the directory service 106 to decide which entity (e.g., person or non-person) identity is presented to the microblogging platform 206. Initially, a user (the person entity 110) selects on a menu of a menu bar via the browser application 204 that accesses a microblogging site hosted on the microblogging platform 206. This user action results in a request being sent to the microblogging platform 206. Upon receiving the request, the platform 206 queries the directory service 106 to find all the groups of which the user is a member. The platform 206 then checks each member group and refines the list of member groups to only those groups in which the user is designated as an owner or a co-owner. This refining operation can be performed through access control list parsing.

The platform 206 caches the results for the user and responds with a list 208 of distributed groups for which the user can post. The list 208 can be presented as menu items for selection by the user. When the user selects an item, the selection is sent to the platform 206 as a post request. The platform 206 receives the request, checks the user's selection, and verifies with the cache that the user indeed can post as the distribution group associated with the selected item.

The platform 206 sets a session cookie value to indicate the user's choice and returns the cookie in a response to the browser application 204. The browser application 204 receives the cookie and reloads the current page. The session cookie is sent with every request the browser application 204 sends to the platform 206 from this point forward. The platform 206 inspects every request coming in for the presence of a cookie value; if the value is present, the platform 206 verifies that user can act as the distribution group 112 associated with the non-person entity 114. The verification is first against the platform cache, and if not in the cache, against the directory service 106. If the distribution group 112 is not already registered as a user in the microblogging platform 206, the microblogging platform 206 automatically provisions the distribution group 112.

The platform 206 then renders the webpage (or website) for the distribution group 112 and sends the rendering to the client (the browser application 204). The browser application 204 presents the user with notification that the user is now acting as the distribution group 112 for the non-person entity 114 on the microblogging platform 206. The notification can also include additional information such as the welcome name and the profile picture for the group 112. The user can then proceed to interact (perform actions such as posting messages) as the distribution group 112.

When a message is posted by a distribution group 112, the platform 206 also records and stores (tracks) the identity of real user (the person-entity 110) that made the request. This can be for auditing purposes, for example.

When user is done acting as the distribution group 112, the user can select a menu item the stops the session. The result is that the user (the proxy user acting on behalf of the non-person entity 114 via the distribution group 112) reverts back to the person-entity identity. The platform 206 then resets the cookie value. Alternatively, the proxy user can simply close the browser application 204 after which the session cookie is deleted.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

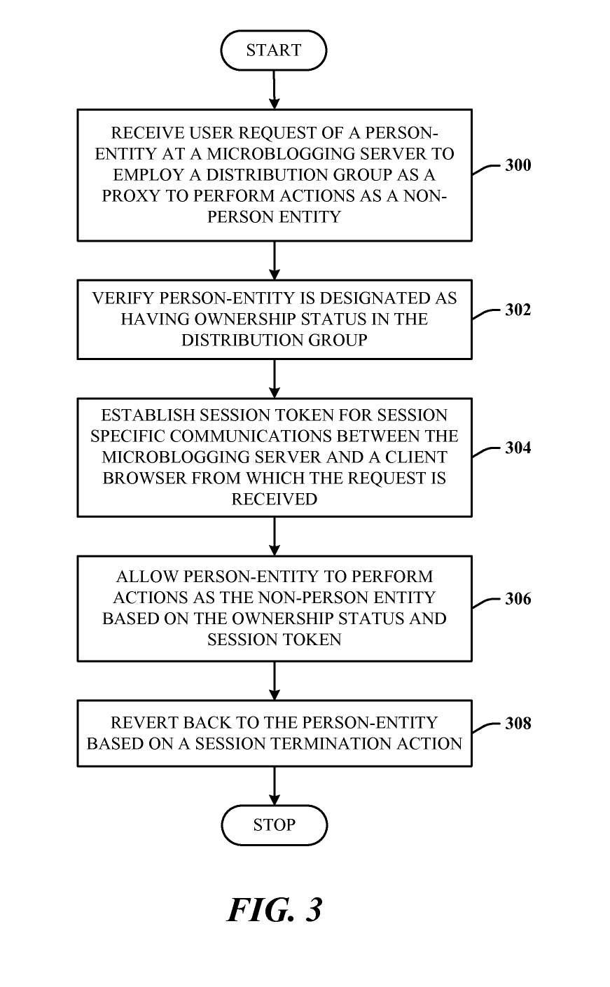

FIG. 3 illustrates a computer-implemented proxy method in accordance with the disclosed architecture. At 300, a user request of a person-entity is received at a microblogging server to employ a distribution group as a proxy to perform actions as a non-person entity. At 302, the person-entity is verified as being designated as having ownership status in the distribution group. At 304, a session token is established for session specific communications between the microblogging server and a client browser from which the request is received. At 306, the person-entity is allowed to perform actions as the non-person entity based on the ownership status and session token. At 308, reversion is back to the person-entity based on a session termination action.

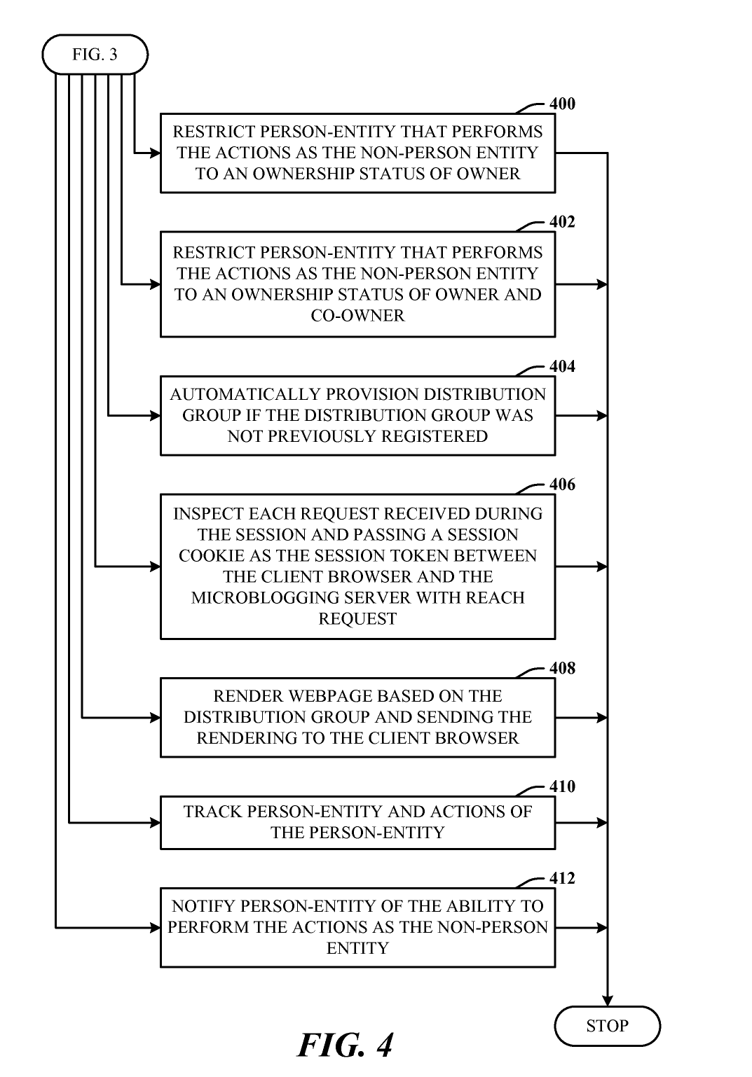

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, the person-entity that performs the actions as the non-person entity is restricted to having an ownership status of owner. At 402, the person-entity that performs the actions as the non-person entity is restricted to having an ownership status of owner and co-owner. At 404, the distribution group is automatically provisioned if the distribution group was not previously registered. At 406, each request received during the session is inspected and a session cookie is passed as the session token between the client browser and the microblogging server with reach request. At 408, a webpage is rendered based on the distribution group and the rendering is sent to the client browser. At 410, the person-entity and the actions of the person-entity are tracked. At 412, the person-entity is notified of the ability to perform the actions as the non-person entity.

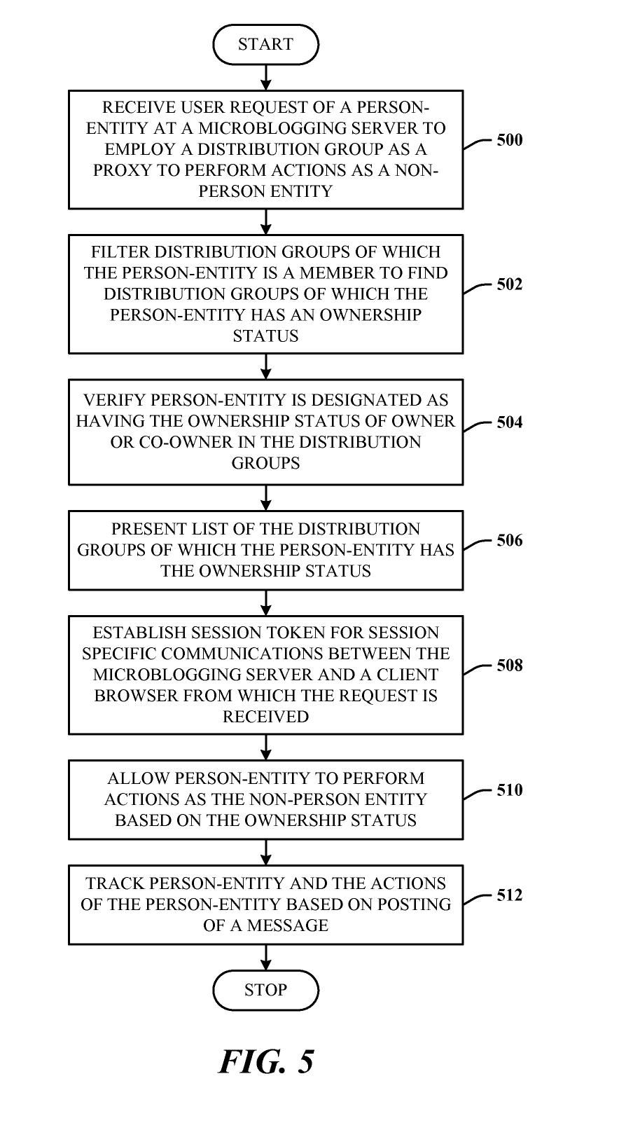

FIG. 5 illustrates an alternative computer-implemented proxy method in accordance with the disclosed architecture. At 500, a user request of a person-entity is received at a microblogging server to employ a distribution group as a proxy to perform actions as a non-person entity. At 502, distribution groups of which the person-entity is a member are filtered to find distribution groups of which the person-entity has an ownership status. At 504, the person-entity is verified as designated as having the ownership status of owner or co-owner in the distribution groups. At 506, a list of the distribution groups of which the person-entity has the ownership status is presented. At 508, a session token for session specific communications is established between the microblogging server and a client browser from which the request is received. At 510, the person-entity is allowed to perform actions as the non-person entity based on the ownership status. At 512, the person-entity and the actions of the person-entity are tracked based on posting of a message.

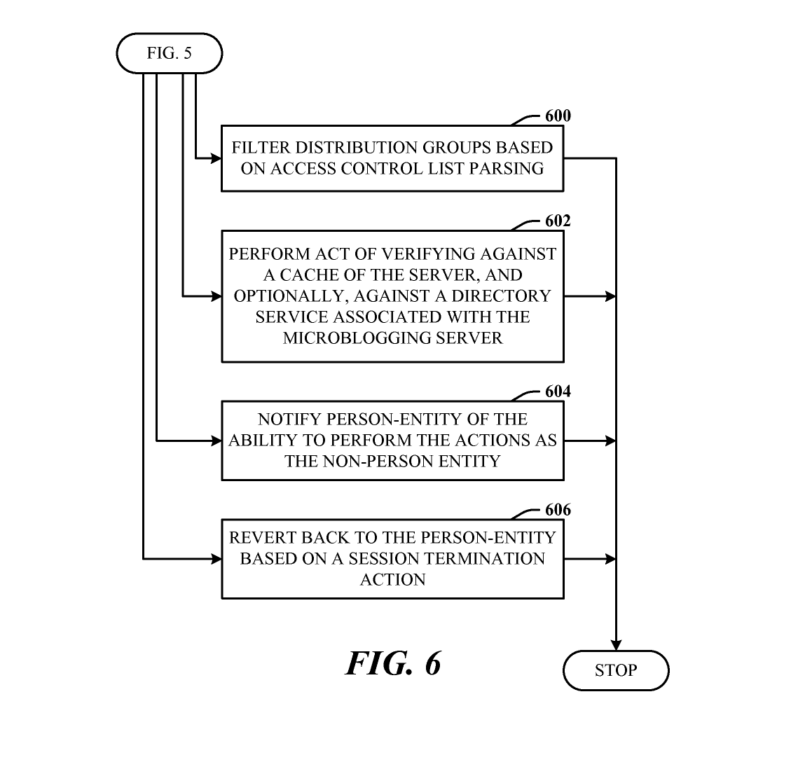

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, the distribution groups are filtered based on access control list parsing. At 602, the act of verifying is performed against a cache of the server, and optionally, against a directory service associated with the microblogging server. At 604, the person-entity is notified of the ability to perform the actions as the non-person entity. At 606, reversion is back to the person-entity based on a session termination action.

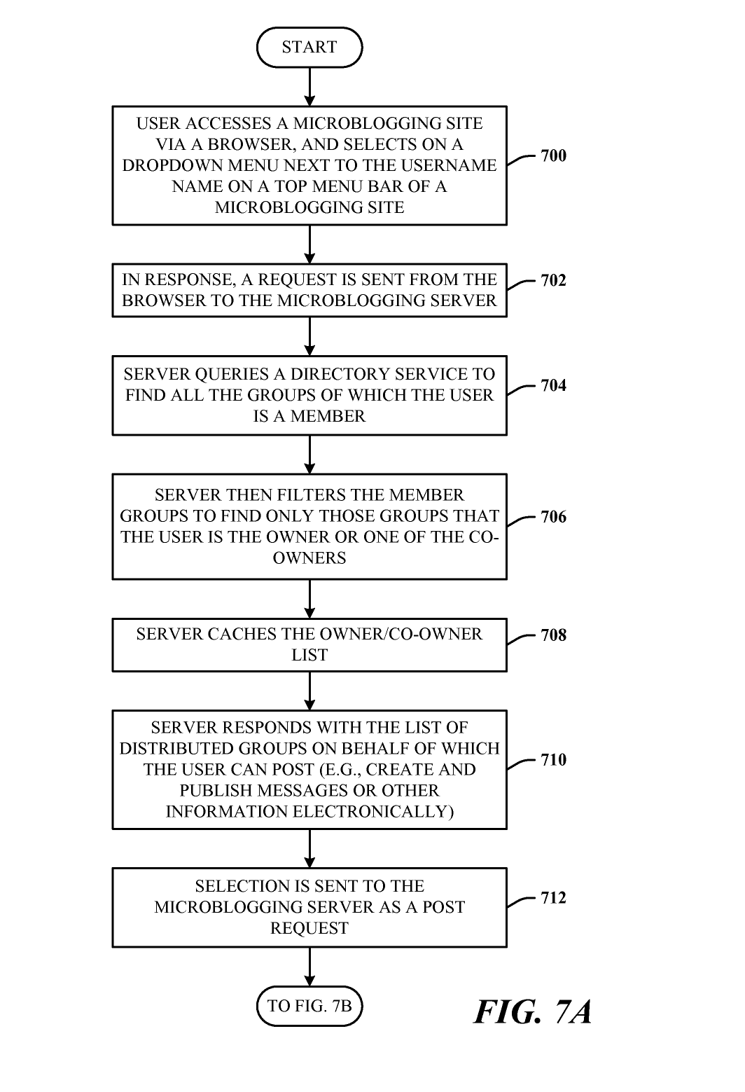

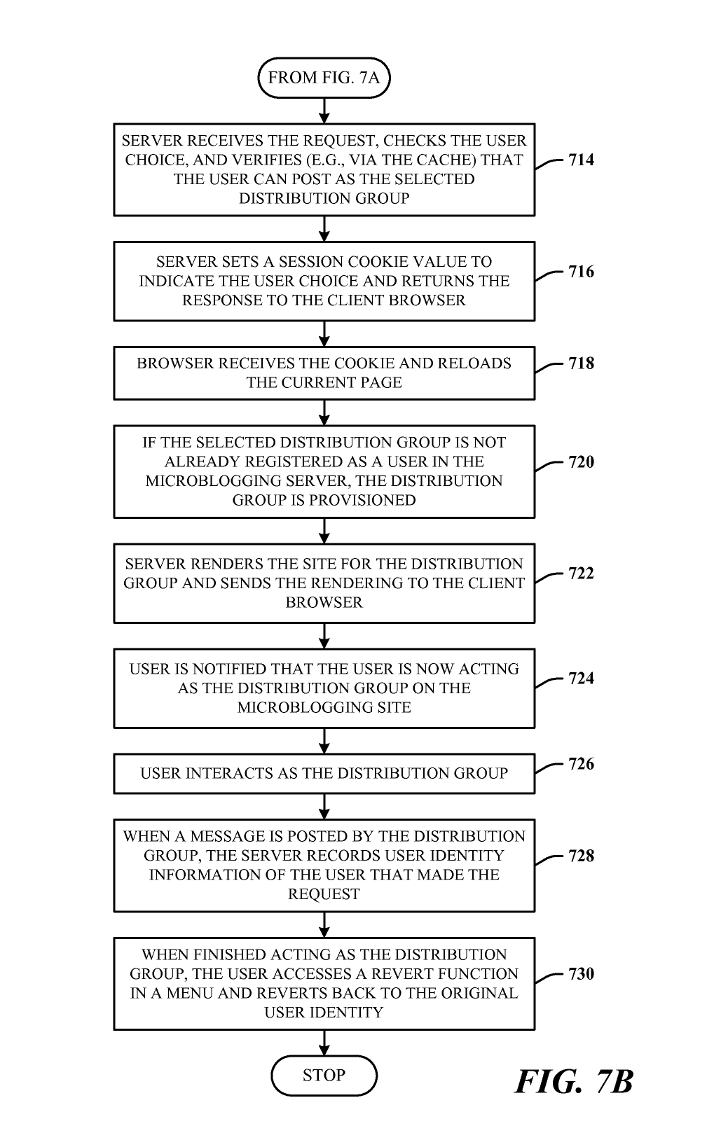

FIG. 7A and FIG. 7B illustrate an alternative proxy method of utilizing distribution groups as a proxy for a non-person entity. Referring initially to FIG. 7A, at 700, a user accesses a microblogging site via a browser, and selects on a dropdown menu next to the username name on a top menu bar of a microblogging site. At 702, in response, a request is sent from the browser to the microblogging server. At 704, the server queries a directory service to find all the groups of which the user is a member. At 706, the server then filters the member groups to find only those groups that the user is the owner or one of the co-owners. This can be accomplished by access control list (ACL) parsing (e.g., discretionary ACL by Active Directory™, a software product by Microsoft Corporation). At 708, the server caches the owner/co-owner list. At 710, the server responds with the list of distributed groups on behalf of which the user can post (e.g., create and publish messages or other information electronically). The groups can be presented as a list menu from which the user selects a distribution group. At 712, the selection is then sent to the microblogging server as a post request.

Referring now to FIG. 7B, at 714, the server receives the request, checks the user choice, and verifies (e.g., via the cache) that the user can post as the selected distribution group. At 716, the server sets a session cookie value to indicate the user choice and returns the response to the client browser. At 718, the browser receives the cookie and reloads the current page. From this point forward, the session cookie accompanies each request the browser sends to the server. The server inspects each request for the presence of the cookie value; if the value is present, the server verifies that the user can indeed act on behalf of the distribution group (first against the cache, and if not in the cache, against the directory service). At 720, if the selected distribution group is not already registered as a user in the microblogging server, the distribution group is provisioned.

At 722, the server then renders the site for the distribution group and sends the rendering to the client browser. At 724, the user is notified that the user is now acting as the distribution group on the microblogging site (e.g., based on a welcome name and a profile picture). At 726, the user interacts as the distribution group (including posting messages). At 728, when a message is posted by the distribution group, the server records user identity information of the user that made the request (e.g., for auditing purposes). At 730, when finished acting as the distribution group, the user accesses a revert function in a menu and reverts back to the original user identity to continue interacting as a person entity (rather than the non-person entity of the distribution group). The server resets the cookie value for this continued use scenario or where the user closes the browser to end the interaction, the server deletes the session cookie.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

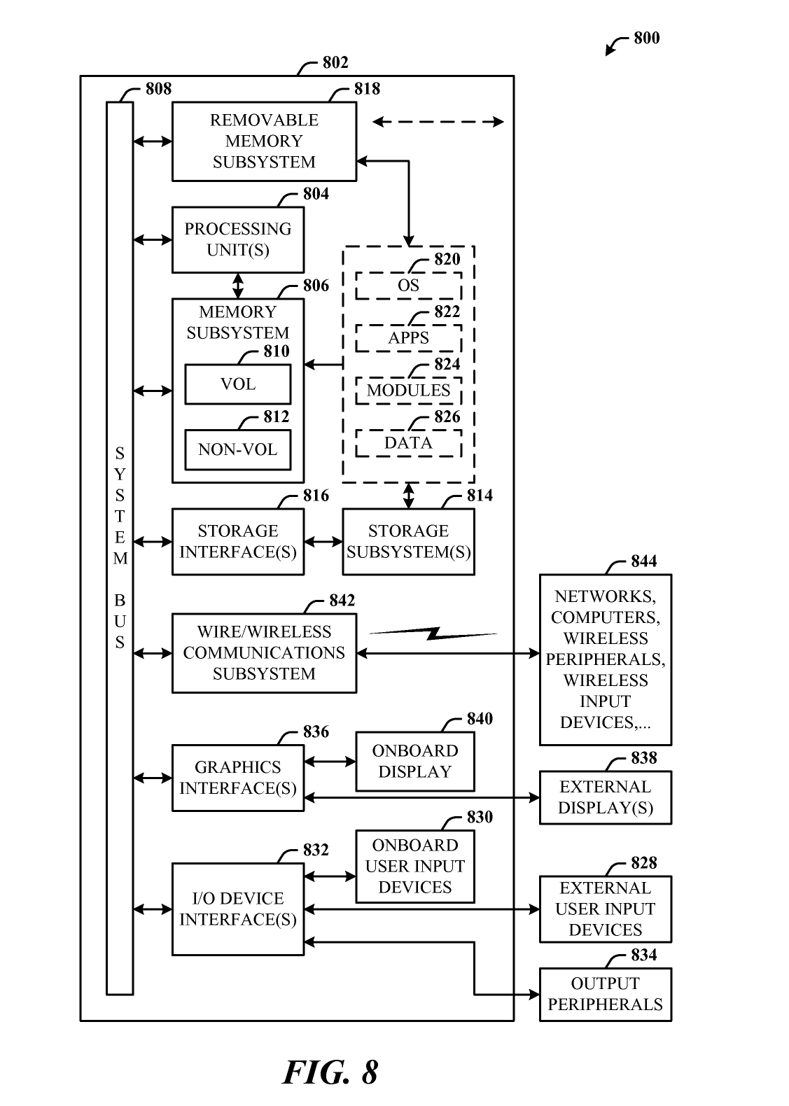

Referring now to FIG. 8, there is illustrated a block diagram of a computing system 800 that executes the proxy of non-person entities using distribution groups in a group infrastructure in accordance with the disclosed architecture. However, it is appreciated that the some or all aspects of the disclosed methods and/or systems can be implemented as a system-on-a-chip, where analog, digital, mixed signal and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The one or more application programs 822, other program modules 824, and program data 826 can include the entities and components of the system 100 of FIG. 1, the entities and components of the system 200 of FIG. 2, and the methods represented by the flowcharts of FIGS. 3-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented proxy system, comprising:
a group infrastructure that includes distribution groups as part of a directory service;
a proxy component that enables a person-entity to utilize a distribution group as a proxy to perform actions as a non-person entity; and
a processor that executes computer-executable instructions associated with at least the directory service.

2. The system of claim 1, wherein the distribution group is associated with a distribution group owner and the owner performs an action on behalf of the non-person entity.

3. The system of claim 1, wherein the distribution group is associated with a distribution group co-owner and the co-owner performs an action on behalf of the non-person entity.

4. The system of claim 1, wherein the directory service is part of an enterprise microblogging platform and the distribution group is a first class user account of the directory service.

5. The system of claim 1, wherein the non-person entity is an enterprise group, enterprise team, enterprise organization, or an enterprise brand.

6. The system of claim 1, wherein the directory service presents a list of distribution groups of which the person-entity is a member and filters the list to distribution groups of which the person-entity has ownership status.

7. The system of claim 1, wherein the group infrastructure tracks the actions of the person-entity performed as the non-person entity.

8. A computer-implemented proxy method, comprising acts of:
receiving a user request of a person-entity at a microblogging server to employ a distribution group as a proxy to perform actions as a non-person entity;
verifying the person-entity is designated as having ownership status in the distribution group;
establishing a session token for session specific communications between the microblogging server and a client browser from which the request is received;
allowing the person-entity to perform actions as the non-person entity based on the ownership status and session token;
reverting back to the person-entity based on a session termination action; and
utilizing a processor that executes instructions stored in memory to perform at least one of the acts of receiving, verifying, establishing, allowing, or reverting.

9. The method of claim 8, further comprising restricting the person-entity that performs the actions as the non-person entity to an ownership status of owner.

10. The method of claim 8, further comprising restricting the person-entity that performs the actions as the non-person entity to an ownership status of owner and co-owner.

11. The method of claim 8, further comprising automatically provisioning the distribution group if the distribution group was not previously registered.

12. The method of claim 8, further comprising inspecting each request received during the session and passing a session cookie as the session token between the client browser and the microblogging server with reach request.

13. The method of claim 8, further comprising rendering a webpage based on the distribution group and sending the rendering to the client browser.

14. The method of claim 8, further comprising tracking the person-entity and the actions of the person-entity.

15. The method of claim 8, further comprising notifying the person-entity of the ability to perform the actions as the non-person entity.

16. A computer-implemented proxy method, comprising acts of:
receiving a user request of a person-entity at a microblogging server to employ a distribution group as a proxy to perform actions as a non-person entity;
filtering distribution groups of which the person-entity is a member to find distribution groups of which the person-entity has an ownership status;
verifying the person-entity is designated as having the ownership status of owner or co-owner in the distribution groups;
presenting a list of the distribution groups of which the person-entity has the ownership status;
establishing a session token for session specific communications between the microblogging server and a client browser from which the request is received;
allowing the person-entity to perform actions as the non-person entity based on the ownership status;
tracking the person-entity and the actions of the person-entity based on posting of a message; and
utilizing a processor that executes instructions stored in memory to perform at least one of the acts of receiving, verifying, establishing, allowing, or reverting.

17. The method of claim 16, further comprising filtering the distribution groups based on access control list parsing.

18. The method of claim 16, further comprising performing the act of verifying against a cache of the server, and optionally, against a directory service associated with the microblogging server.

19. The method of claim 16, further comprising notifying the person-entity of the ability to perform the actions as the non-person entity.

20. The method of claim 16, further comprising reverting back to the person-entity based on a session termination action.
